(19) United States
(12) Patent Application Publication
(10) Pub. No.: US 2006/0294539 A1
(43) Pub. Date: Dec. 28, 2006

(54) Display apparatus and control method thereof and broadcast processing apparatus

(75) Inventors: Mun-seok Kim, Suwon-si (KR); Kyoung-mi Jin, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/334,561

(22) Filed: Jan. 19, 2006

(30) Foreign Application Priority Data
Jun. 27, 2005 (KR) 10-2005-0055945

(51) Int. Cl. H04N 7/16

(52) U.S. Cl. 725/28; 725/25

(57) ABSTRACT

The present invention provides a display apparatus and a control method thereof which can more efficiently protect a user by originally interrupting a view limitation broadcast program by interrupting a broadcast in advance before the broadcast is interrupted by a view limitation function. A display apparatus includes a broadcast output part for outputting at least one of a video and a sound; a processor processing the broadcast signal to supply to the broadcast output part; a user input part for converting a channel; and a controller for controlling the processor so that a broadcast program of a converted channel is not output through the broadcast output part, during a predetermined determining time when it is determined whether the broadcast program based on the broadcast signal of the converted channel is a view limitation program on the basis of the rating information.

### CROSS-REFERENCE TO RELATED APPLICATIONS

This application claims priority from Korean Patent Application No. 10-2005-0055945, filed on Jun. 27, 2005, in the Korean Intellectual Property Office, the disclosure of which is incorporated herein by reference.

### BACKGROUND OF INVENTION

1. Field of Invention

Apparatuses and methods consistent with the present invention relate to a display apparatus and a control method thereof and a broadcast processing apparatus, and more particularly, to interrupting a broadcast in advance before the broadcast is interrupted by a view limitation function which more efficiently protects a user by originally interrupting a view limitation broadcast program.

2. Description of the Related Art

Generally, a television apparatus that receives a broadcast signal is a home appliance that is possessed in most homes. Further, anyone in the home can be exposed to programming received by the television apparatus. Therefore, there is a problem that children or teenagers can potentially be exposed to a broadcast program that is unsuitable to them among the broadcast programs which are received by the television apparatus.

Accordingly, the television apparatus needs a view limitation function, such as a V-chip. The view limitation function distinguishes a broadcast program that is capable of being viewed by a viewer among the broadcast programming which is received. Hereinafter, the view limitation function will be described.

First of all, a base station sends a broadcast signal for broadcasting the broadcast program, which is supplied together with rating information of the broadcast program. The conventional television apparatus stores view limitation rating information, which is preset by an input operation of a user and limits the programming that can be viewed according to the program rating information. Therefore, when a user changes the channel being viewed, the television apparatus selects the broadcast signal of the selected channel, and then broadcasts an appropriate broadcast program by processing the selected and received broadcast signal. At this time, the television apparatus determines whether the broadcast program based on the broadcast signal is a view limited program by extracting the rating information in a processing of the broadcast signal and comparing the rating information with the preset view limitation rating information. Therefore, if the broadcast program is determined to be a view limited program (i.e., the preset view limitation rating information indicates that viewing of a program having the rating information is to be prevented), the television apparatus mutes video and sound so as prevent viewing of the broadcast program.

As above, the conventional television apparatus supplying the view limitation function distinguishes and allows viewing of a view enabled broadcast program on the basis of the rating information of the broadcast signal that is received according to the channel change and the preset view limitation rating information, whenever a channel change operation occurs.

However, even though a broadcast program being broadcast on a channel which a viewer selects is a view limited program, the conventional television apparatus broadcasts the view limited program for a period of time before the broadcast is muted, since the channel change operation has already finished while the television apparatus determines that the broadcast program related to the selected channel is a view limited program.

### SUMMARY OF THE INVENTION

Accordingly, it is an aspect of the present invention to provide a display apparatus and a control method thereof and a broadcast processing apparatus which can more efficiently protect a user by originally interrupting a view limitation broadcast program by interrupting a broadcast in advance before the broadcast is interrupted by a view limitation function.

According to an aspect of the present invention, there is provided a display apparatus for receiving a broadcast signal including rating information which supports a view limitation function according to the rating information, the display apparatus comprising: a broadcast output part which outputs at least one of video and sound; a processor which processes the received broadcast signal to supply to the broadcast output part; an input part which receives an input of a channel change operation to select a channel; and a controller which controls the processor to prevent output of a broadcast program which is broadcast on the channel that is selected through the broadcast output part during a predetermined determining time in which the controller determines whether the broadcast program which is broadcast on the channel that is selected is a view limitation program on the basis of the rating information if the view limitation function is enabled.

According to an aspect of the present invention, the controller determines whether the received rating information included in the broadcast signal of the channel which is selected is below a predetermined view limitation rating which is preset in the determining whether the broadcast program which is broadcast on the channel which is selected is a view limitation program if the view limitation function is enabled.

According to an aspect of the present invention, the controller controls the processor to output the broadcast program, which is broadcast on the channel that is selected, through the broadcast output part if the rating information which is received is determined to be below the view limitation rating.

According to an aspect of the present invention, the controller controls the processor to prevent output of the broadcast program, which is broadcast on the channel which is selected, through the broadcast output part if the rating information which is received is determined not to be below the view limitation rating.

According to an aspect of the present invention, the rating information comprises view age rating information which indicates an age of a viewer which is allowed to view the broadcast program.

According to an aspect of the present invention, the broadcast output part comprises a display part which displays video of the broadcast signal which is supplied from the processor; and the controller controls the processor to display a predetermined standby screen during the predetermined determining time in which the controller determines whether the broadcast program which is broadcast on the channel which is selected is a view limitation program on the basis of the rating information which is received.

According to an aspect of the present invention, the broadcast output part comprises a sound output part which outputs sound of the broadcast signal which is supplied from the processor; and the controller controls the processor to output a predetermined standby sound through the sound output part during the predetermined determining time in which the controller determines whether the broadcast program which is broadcast on the channel which is selected is a view limitation program on the basis of the rating information which is received.

According to an aspect of the present invention, the controller controls the processor to display video of the broadcast program, which is broadcast on the channel which is selected, on the display part and to output sound of the broadcast program to the sound output part, if the rating information which is received is determined to be below the view limitation rating.

According to an aspect of the present invention, the standby screen comprises at least one of a mute screen, a blue screen, and a prestored capture screen; and the standby sound comprises at least one of a mute sound, a single sound, and a prestored melody.

According to another aspect of the present invention, there is provided a broadcast processing apparatus for receiving a broadcast signal including rating information which supports a view limitation function according to the rating information, the broadcast apparatus comprising: a broadcast output part which outputs at least one of video and sound; a processor which processes the received broadcast signal to supply to the broadcast output part; an input part which receives an input of a channel change operation to select a channel; and a controller which controls the processor to prevent output of a broadcast program which is broadcast on the channel that is selected through the broadcast output part during a predetermined determining time in which the controller determines whether the broadcast program which is broadcast on the channel which is selected is a view limitation program on the basis of the rating information if the view limitation function is enabled.

According to another aspect of the present invention, there is provided a control method of a display apparatus including an input part, a receiver which receives a broadcast signal including rating information, and a broadcast output part which outputs at least one of video and sound, and supporting a view limitation function according to the rating information, the control method comprising: determining whether a channel is selected by a channel change operation through the input part; determining whether the view limitation function is enabled if the channel change operation occurs; preventing the broadcast output part from outputting a broadcast program which is broadcast on the channel which is selected if the view limitation function is enabled; and determining whether the broadcast program which is broadcast on the channel which is selected is a view limitation program based on the rating information which is received.

According to an aspect of the present invention, the determining whether the broadcast program which is broadcast on the channel which is selected is a view limitation program comprises determining whether the rating information which is received and included in the broadcast signal of the channel which is selected is below a predetermined view limitation rating which is preset.

The control method of the display apparatus further comprises outputting the broadcast program, which is broadcast on the channel which is selected, through the broadcast output part if the rating information which is received is determined to be below the view limitation ration.

According to an aspect of the present invention, the rating information comprises viewer age rating information which indicates an age of a viewer which is allowed to view the broadcast program.

According to an aspect of the present invention, the preventing the broadcast output part from outputting the broadcast program which is broadcast on the channel which is selected comprises outputting a predetermined standby screen.

According to an aspect of the present invention, the preventing the broadcast output part from outputting the broadcast program which is broadcast on the channel which is selected comprises outputting a predetermined standby sound.

According to an aspect of the present invention, the outputting the broadcast program, which is broadcast on the channel which is selected, through the broadcast output part comprises outputting video and sound of the broadcast program based on the broadcast signal of the channel, which is selected, through the broadcast output part.

According to an aspect of the present invention, the standby screen comprises at least one of a mute screen, a blue screen, and a prestored capture screen; and the standby sound comprises at least one of a mute sound, a single sound, and a prestored melody.

### BRIEF DESCRIPTION OF THE DRAWINGS

The above and other aspects of the present invention will become apparent and more readily appreciated from the following description of the exemplary embodiments, taken in conjunction with the accompany drawings, in which:

FIG. 1 is a control block diagram of a display apparatus according to an exemplary embodiment of the present invention; and

FIG. 2 is a control flow diagram of the display apparatus according to an exemplary embodiment of the present invention.

### DETAILED DESCRIPTION OF THE EXEMPLARY EMBODIMENTS OF THE INVENTION

Reference will now be made in detail to exemplary embodiments of the present invention, examples of which are illustrated in the accompanying drawings, wherein like reference numerals refer to like elements throughout. The exemplary embodiments are described below with reference to the accompanying drawings.

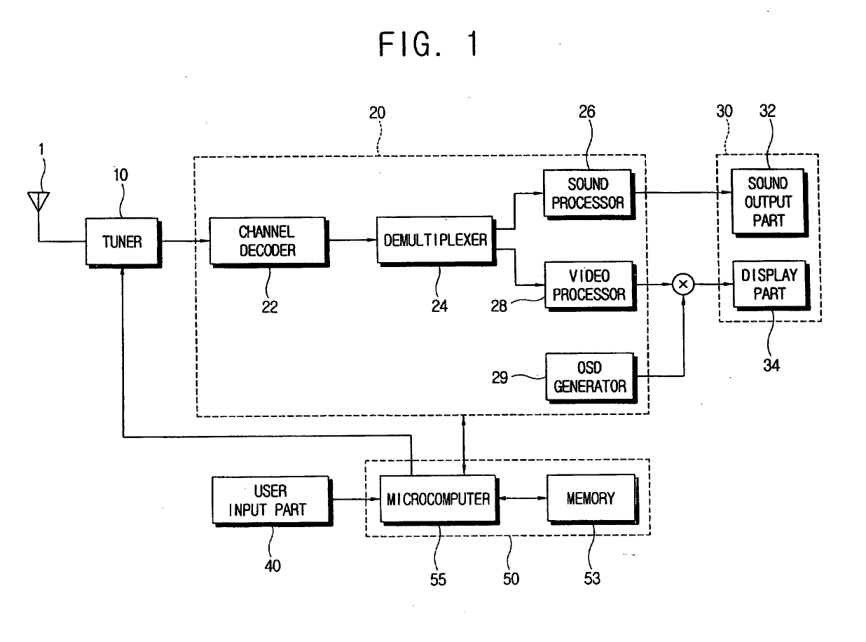

FIG. 1 is a control block diagram of a display apparatus according to an exemplary embodiment of the present invention. As shown therein, the display apparatus according to an exemplary embodiment of the present invention includes an antenna 1 for receiving a broadcast signal, a tuner 10, a processor 20, a broadcast output part 30, a user input part 40, and a controller 50.

The user input part 40 serves as an information input device for inputting a key by a user. The user input part 40 is provided with a remote controller (not shown) used as a key input part for operating the key by the user and a receiving part (not shown) for receiving a wireless key input signal sent from the remote controller (not shown). The user input part 40 may be provided with a wire line in a main body of the display apparatus.

The tuner 10 selects the broadcast signal having a frequency area corresponding to a control signal of the controller 50 among the broadcast signals that are received through the antenna 1. That is, the tuner 10 selects only the broadcast signal corresponding to the channel broadcasted through the broadcast output part 30 among a plurality of broadcast signals received through the antenna 1 and outputs the selected broadcast signal to the processor 20. At this time, the selected broadcast signal may include rating information of a broadcast program based on the broadcast signal.

The broadcast output part 30 serves as an output part for outputting the broadcast program based on the broadcast signal selected through the tuner 10. The broadcast output part 30 includes a display part 34 for displaying video of the broadcast program and a sound output part 32 for outputting sound of the broadcast program.

The processor 20 serves as a processing part for processing the broadcast signal which is selected through the tuner 10 to be output through the broadcast output part 30. Such a processor 20 includes a channel decoder 22 for demodulating an IF broadcast signal of the broadcast signal, which is selected through the tuner 10, into a predetermined transport stream of a packet unit and outputting the transport stream, and a demultiplexer 24 for separating the sound signal, the video signal, and data information of an appropriate channel, which are switched over from the transport stream output from the channel decoder 22, into a respective bit stream and outputting the bit stream to a sound processor 26, a video processor 28, a data processor (not shown). Herein, the data information which is separated from the transport stream by the demultiplexer 24, may be include a Program Map Table (PMT) having the rating information of the broadcast program of the appropriate channel. The rating information includes viewer age rating information according to the broadcast program that the viewer can view. Table 1, provided below, is only an example illustrating such viewer age rating information.

TABLE 1

| Rating information | Viewer age rating information |
|---|---|
| V-19 | Preferably viewer above 19 years of age |
| V-16 | Preferably viewer above 16 years of age |
| V-13 | Preferably viewer above 13 years of age |
| V-7 | Preferably viewer above 7 years of age |

Herein, the data processor (not shown) may be included in the controller 50. As below, the function of the data processor (not shown) will be illustrated as the function of the controller 50.

Further, the processor 20 includes a sound processor 26 to convert the sound signal separated at the demultiplexer 24 into an analog signal and then output the analog signal to a sound output part 32, a video processor 28 to convert the video signal output from the demultiplexer 24 into a signal of a format which can be displayed by the display part 34, and supply the video signal in the appropriate format to the display part 34, and an On Screen Display (OSD) generator 29 to generate a predetermined OSD screen. In addition, the sound processor 26 may perform a signal process such as a sound equalizer process, a mono process, a stereo process, a surround process, an echo process and the like by controlling of the controller 50, and the sound processor 26 may allow a predetermined mute sound, a single sound, or a prestored melody to be output through the sound output part 32.

The OSD generator 29 may form a mute screen (i.e., a block screen) or a blue screen for muting the video so as not to display the video of the broadcast program through the broadcast output part 30 by controlling of the controller 50.

The controller 50 includes a microcomputer 55 and a memory 53.

The microcomputer 55 sets or stores view limitation rating information, which is input by an input operation of the user through the user input part 40 in the memory 53. Further, the microcomputer 55 determines that the view limitation function is set as ON or OFF by the operation of the user input part 40 or the user control menu (not shown), and then the microcomputer 55 stores the ON/OFF set state of the view limitation function in the memory 53.

The microcomputer 55 determines whether a channel change operation is input through the user input part 40. In case that a channel change operation is input, the microcomputer 55 determines that the view limitation function is set as the ON based on the ON/OFF set state of the view limitation function stored at the memory 53. If the view limitation function is determined to be in the ON state, the microcomputer 55 controls the tuner 10 so as to select the broadcast signal of the channel which is selected by the channel change operation.

At this time, the microcomputer 55 controls the processor 20 so that a predetermined standby screen is displayed through the display part 34 and a predetermined standby sound is output through the sound output part 32. The standby screen may include at least one of the mute screen, the blue screen, and the prestored capture screen. The standby sound may include at least one of the mute sound, a single sound, and the prestored melody. In the following example, the standby screen is the mute screen (i.e., the block screen) and the standby sound is the mute sound. Therefore, the microcomputer 55 controls the tuner 10 and simultaneously controls the OSD generator 29 so as to display the mute screen in the display part 34 and the sound processor 26 so as to output the mute sound through the sound output part 32.

Thus, the microcomputer 55 controls the processor 20 so as to process the selected broadcast, in a state that the video and the sound are muted through the broadcast output part 30. In a processing of the selected broadcast signal, the microcomputer 55 receives the data information from the demultiplexer 24 and then extracts the rating information of the broadcast program based on the broadcast signal from the PMT information of the data information.

Therefore, the microcomputer 55 determines whether the broadcast program based on the broadcast signal which is selected in the channel change operation is a view limitation program, by comparing the extracted rating information with the view limitation rating information preset and stored at the memory 53. That is, the microcomputer 55 determines that the broadcast program is a view enable program if the rating information of the broadcast program is below the view limitation rating that has been set. If the microcomputer 55 determines that the broadcast program of the selected broadcast signal is a view enable program, the microcomputer 55 controls the video processor 28, the sound processor 26, and the OSD generator 29 so as to output the video and the sound of the broadcast program according to the selected broadcast signal through the broadcast output part 30 by interrupting the output of the mute screen and the mute sound.

The microcomputer 55 determines that the broadcast program is a view limited program if the rating information of the broadcast program is not below the view limitation rating. If the microcomputer 55 determines that the broadcast program of the selected broadcast signal is a view limited program, the microcomputer 55 controls the video processor 28, the sound processor 26, and the OSD generator 29, so as to maintain the mute screen and the mute sound output.

Therefore, the display apparatus according to an exemplary embodiment of the present invention immediately outputs the mute screen and the mute sound through the broadcast output part 30 as soon as the channel change operation is input if the view limitation function is set to the ON state, and maintains the mute screen and the mute sound output until the display apparatus determines that a broadcast program on a channel which has been selected in a channel change operation is a view limited program. Thus, the display apparatus according to an exemplary embodiment of the present invention interrupts initially the broadcast in the channel change operation when the view limitation function is the ON set state, thereby preventing the broadcast program from being output in a period of time before the broadcast is muted in case the broadcast program of the channel selected in the channel change operation is determined to be a view limited program.

As shown in FIG. 1, the display apparatus according to an exemplary embodiment of the present invention includes the broadcast output part 30 including the display part 34 and the sound output part 32 as an example. Alternatively, the display part 34 and the sound output part 32 may be provided with a respective device which is separate from the broadcast output part 30. Further, the broadcast output part 30 may be provided with a port part (not shown) supplying the video and the sound to the respective device (not shown). That is, if the broadcast output part 30 may be provided with the port part (not shown), the configuration of the FIG. 1 may be utilized as an example of a broadcast processing device such as a set top box. To perform the view limitation function more efficiently and certainly, exemplary embodiments of the present invention may employ either the broadcast processing device or the display apparatus of the integral type comprising the function of the set top box and the display part 34 and the sound output part 32.

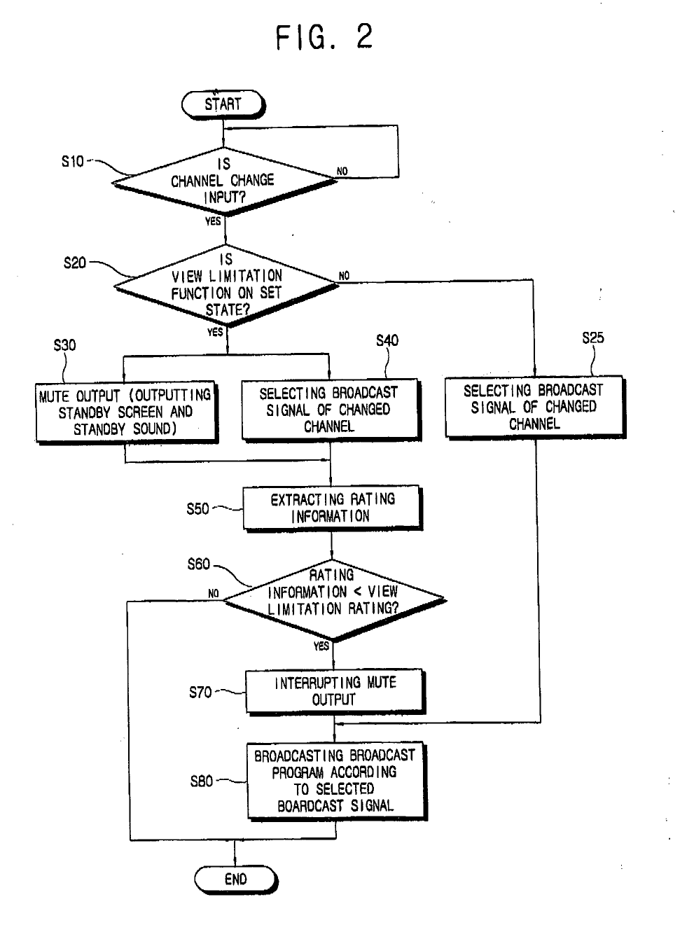

A control flow of the display apparatus according to an exemplary embodiment of the present invention having this configuration will be described with reference to FIG. 2 as below. First of all, the view limitation rating information (i.e., V-16) set according to the input of the user through the user input part 40 and the ON/OFF set state of the view limitation function is stored in memory 53.

At operation S10, the microcomputer 55 determines whether a channel change operation is input through the user input part 40. In case that a channel change operation is input, at operation S20, the microcomputer 55 determines whether the view limitation function is the ON set state on the basis of the ON/OFF set state of the view limitation function stored in the memory 53. If the view limitation function is the OFF set state, at operation S25, the microcomputer 55 controls the tuner 10 so as to select the broadcast signal of the channel which is selected by the channel change operation, and at operation S80, the microcomputer 55 controls the processor 20 so that the video and the sound of the broadcast program according to the selected broadcast signal is output through the broadcast output part 30.

Herein, at operation S20, if the view limitation function is determined to be in the ON set state, the microcomputer 55 controls the tuner 10 so as to select the broadcast signal of the channel which is selected by the channel change operation. At the same time, at operation S30, the microcomputer 55 controls the processor 20 so that the mute screen is displayed through the display part 34 and the mute sound is output through the sound output part 32.

The microcomputer 55 controls the processor 20 so as to process the selected broadcast signal, in a state that the video and the sound output through the broadcast output part 30 are muted. At operation S50, the microcomputer 55 receives the data information received along with the broadcast signal from the demultiplexer 24 in a processing of the selected broadcast signal, and then extracts the rating information of the broadcast program based on the broadcast signal from the PMT information of the data information. Therefore, the microcomputer 55 determines that the broadcast program based on the broadcast signal of the selected channel is a view limitation program by comparing the extracted rating information with the view limitation rating information stored at the memory 53. That is, at operation S60, the microcomputer 55 determines whether the rating information is below the view limitation rating based on the comparison of the rating information with the view limitation rating information. At operation S70, if the microcomputer 55 determines that the rating information (i.e., V-13) is below the view limitation rating (i.e., V-16), the microcomputer 55 controls the video processor 28, the sound processor 26, and the OSD generator 29, at operation S80, so as to output the video and the sound of the broadcast program according to the selected broadcast signal through the broadcast output part 30, at operation S70, by interrupting the mute screen and the mute sound from outputting.

At operation S60, if the microcomputer 55 determines that the rating information (i.e., V-19) is not below the view limitation rating (i.e., V-16), the microcomputer 55 determines that the broadcast program of the selected broadcast signal is a view limited program, thereby maintaining the mute screen and the mute sound.

Therefore, the control method of the display apparatus according to an exemplary embodiment of the present invention directly interrupts the output of a broadcast program if a channel change operation is input in a state where the view limitation function is set to the ON state, thereby preventing the broadcast program from being output in a moment before the broadcast is muted, in case the broadcast program of the selected channel is the view limited program.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display apparatus for receiving a broadcast signal including rating information which supports a view limitation function according to the rating information, the display apparatus comprising:
a broadcast output part which outputs at least one of video and sound;
a processor which processes the received broadcast signal to supply to the broadcast output part;
an input part which receives an input of a channel change operation to select a channel; and
a controller which controls the processor to prevent output of a broadcast program which is broadcast on the channel that is selected through the broadcast output part during a predetermined determining time in which the controller determines whether the broadcast program which is broadcast on the channel that is selected is a view limitation program based on the rating information if the view limitation function is enabled.

2. The display apparatus according to claim 1, wherein the controller determines whether the rating information which is received and included in the broadcast signal of the channel which is selected is below a predetermined view limitation rating which is preset in the determining whether the broadcast program which is broadcast on the channel which is selected is a view limitation program, if the view limitation function is enabled.

3. The display apparatus according to claim 2, wherein the controller controls the processor to output the broadcast program, which is broadcast on the channel which is selected, through the broadcast output part if the rating information which is received is determined to be below the view limitation rating.

4. The display apparatus according to claim 3, wherein the controller controls the processor to prevent output of the broadcast program, which is broadcast on the channel which is selected, through the broadcast output part if the rating information which is received is determined not to be below the view limitation rating.

5. The display apparatus according to claim 4, wherein the rating information comprises view age rating information which indicates an age of a viewer which is allowed to view the broadcast program.

6. The display apparatus according to claim 5, wherein the broadcast output part comprises a display part which displays video of the broadcast signal which is supplied from the processor; and
the controller controls the processor to display a predetermined standby screen on the display part, during the predetermined determining time in which the controller determines whether the broadcast program which is broadcast on the channel which is selected is a view limitation program based on the rating information which is received.

7. The display apparatus according to claim 6, wherein the broadcast output part comprises a sound output part which outputs sound of the broadcast signal which is supplied from the processor; and
the controller controls the processor to output a predetermined standby sound through the sound output part, during the predetermined determining time in which the controller determines whether the broadcast program which is broadcast on the channel which is selected is a view limitation program based on the rating information which is received.

8. The display apparatus according to claim 7, wherein the controller controls the processor to display video of the broadcast program, which is broadcast on the channel which is selected, on the display part and to output sound of the broadcast program to the sound output part, if the rating information which is received is determined to be below the view limitation rating.

9. The display apparatus according to claim 8, wherein the standby screen comprises at least one of a mute screen, a blue screen, and a prestored capture screen; and
the standby sound comprises at least one of a mute sound, a single sound, and a prestored melody.

10. A broadcast processing apparatus for receiving a broadcast signal including rating information which supports a view limitation function according to the rating information, the broadcast apparatus comprising:
a broadcast output part which outputs at least one of video and sound;
a processor which processes the received broadcast signal to supply to the broadcast output part;
an input part which receives an input of a channel change operation to select a channel; and
a controller which controls the processor to prevent output of a broadcast program which is broadcast on the channel that is selected through the broadcast output part during a predetermined determining time in which the controller determines whether the broadcast program which is broadcast on the channel which is selected is a view limitation program based on the rating information if the view limitation function is enabled.

11. A control method of a display apparatus including a input part, a receiver which receives a broadcast signal including rating information, and a broadcast output part which outputs at least one of video and sound, and supporting a view limitation function according to the rating information, the method comprising:
determining whether a channel is selected by a channel change operation through the input part;
determining whether the view limitation function is enabled if the channel change operation occurs;
preventing the broadcast output part from outputting a broadcast program which is broadcast on the channel which is selected if the view limitation function is enabled; and
determining whether the broadcast program which is broadcast on the channel which is selected is a view limitation program based on the rating information which is received.

12. The control method of the display apparatus according to claim 11, wherein the determining whether the broadcast program which is broadcast on the channel which is selected is a view limitation program comprises determining whether the rating information which is received and included in the broadcast signal of the channel which is selected is below a predetermined view limitation rating which is preset.

13. The control method of the display apparatus according to claim 12, further comprising outputting the broadcast program, which is broadcast on the channel which is selected, through the broadcast output part if the rating information which is received is determined to be below the view limitation ration.

14. The control method of the display apparatus according to claim 13, wherein the rating information comprises viewer age rating information which indicates an age of a viewer which is allowed to view the broadcast program.

15. The control method of the display apparatus according to claim 14, wherein the preventing the broadcast output part from outputting the broadcast program which is broadcast on the channel which is selected comprises outputting a predetermined standby screen through the broadcast output part.

16. The control method of the display apparatus according to claim 15, wherein the preventing the broadcast output part from outputting the broadcast program which is broadcast on the channel which is selected comprises outputting a predetermined standby sound through the broadcast output part.

17. The control method of the display apparatus according to claim 16, wherein the outputting the broadcast program, which is broadcast on the channel which is selected, through the broadcast output part comprises outputting video and sound of the broadcast program based on the broadcast signal of the channel, which is selected, through the broadcast output part.

18. The control method of the display apparatus according to claim 17, wherein the standby screen comprises at least one of a mute screen, a blue screen, and a prestored capture screen; and
the standby sound comprises at least one of a mute sound, a single sound, and a prestored melody.

19. A display apparatus for receiving a broadcast signal including rating information, the display apparatus comprising:
a broadcast output part which outputs at least one of video and sound;
a processor which processes the broadcast signal to supply the broadcast signal which is received to the broadcast output part; and
a controller which controls the processor to prevent output of a broadcast program which is broadcast on a channel that is selected through the broadcast output part during a predetermined determining time in which the controller determines whether the broadcast program which is broadcast on the channel that is selected is a view limitation program based on the rating information if a view limitation function is enabled.

20. The display apparatus according to claim 19, wherein the controller determines whether the rating information which is received and included in the broadcast signal of the channel which is selected is below a predetermined view limitation rating which is preset in the determining whether the broadcast program which is broadcast on the channel which is selected is a view limitation program, if the view limitation function is enabled.

21. The display apparatus according to claim 20, wherein the controller controls the processor to output the broadcast program, which is broadcast on the channel which is selected, through the broadcast output part if the rating information which is received is determined to be determined to be below the view limitation rating.

22. The display apparatus according to claim 21, wherein the controller controls the processor to prevent output of the broadcast program, which is broadcast on the channel which is selected, through the broadcast output part if the rating information which is received is determined not to be below the view limitation rating.

23. The display apparatus according to claim 22, wherein the rating information comprises view age rating information which indicates an age of a viewer which is allowed to view the broadcast program.
